(19) United States
(12) Patent Application Publication
(10) Pub. No.: US 2015/0138326 A1
(43) Pub. Date: May 21, 2015

(54) DISPLAY APPARATUS AND CONTROL METHOD THEREOF

(71) Applicant: Samsung Electronics Co., Ltd., Suwon-si (KR)

(72) Inventors: Ji-yong PARK, Suwon-si (KR); Min-jung KIM, Seoul (KR)

(73) Assignee: SAMSUNG ELECTRONICS CO., LTD., Suwon-si (KR)

(21) Appl. No.: 14/528,048

(22) Filed: Oct. 30, 2014

(30) Foreign Application Priority Data
Nov. 19, 2013 (KR) 10-2013-0140800

(51) Int. Cl. H04N 13/04; H04N 17/00

(52) U.S. Cl. CPC H04N 13/0425; H04N 17/004
USPC 348/51

(57) ABSTRACT

Provided are a display apparatus for three-dimensional (3D) communication and a control method thereof. The display apparatus includes: a communicator configured to transmit and receive information for the 3D image communication; an image processor configured to process a received image received through the communicator and to process a first image captured by a first imaging device and a second image captured by a second imaging device; a displayer configured to display the processed first image and the processed second image; and a controller configured to, in response to a first characteristic value of the first image and a second characteristic value of the second image being different from each other, calibrate at least one of the first image and the second image so that the first characteristic value is equal to the second characteristic value.

### CROSS-REFERENCE TO RELATED APPLICATION

This application claims priority from Korean Patent Application No. 10-2013-0140800, filed on Nov. 19, 2013 in the Korean Intellectual Property Office, the disclosure of which is incorporated herein by reference in its entirety.

### BACKGROUND

1. Field

Apparatuses and methods consistent with exemplary embodiments relate to a display apparatus and a control method thereof, and more particularly to a display apparatus used for three-dimensional (3D) image communication and a control method thereof, in which a difference in a characteristic value among a plurality of images for a 3D image of a user is prevented by calibrating a difference in an image characteristic value between a plurality of imaging devices.

2. Description of the Related Art

Image communication using a display apparatus has been achieved by a general imaging device. With the development of the Internet and smart display apparatuses, it can be expected that uses of the image communication using the display apparatus will be increased. Also, the age of 3D image communication is approaching as a 3D construction environment is developed. Further, the development of a display apparatus that displays a 3D image in a glassless mode may bring increased demand for a 3D image imaging device.

In the case of image communication using a two dimensional (2D) display apparatus 10, a camera 12 is placed at an upper side of the display apparatus 10 and therefore eyes of users A and B who are conducting the image communication may not be properly directed. Accordingly, various methods have been proposed. As shown in (a) and (b) of FIG. 1, the users A and B cannot look into each other's eyes while conducting the image communication.

In the case of 3D image communication using a 3D display apparatus 10, a 3D imaging device or two or more imaging devices 14 and 16 are used, as shown in FIG. 2. However, if the two or more imaging devices 14 and 16 are used, differences in a characteristic between the imaging devices 14 and 16 may cause the photographed images to have different color characteristics, thereby deteriorating the quality of the 3D image.

### SUMMARY

One or more exemplary embodiments may provide a display apparatus and a control method thereof, in which a first characteristic value of a first image taken for 3D image communication by a first imaging device and a second characteristic value of a second image taken by a second imaging device are compared, and when the first characteristic value and the second characteristic value are different, an image is calibrated to make the first characteristic value and the second characteristic value equal to each other.

According to an aspect of an exemplary embodiment, there is provided a display apparatus for three-dimensional (3D) image communication, the display including: a communicator configured to transmit and receive information for the 3D image communication; an image processor configured to process a received image received through the communicator and to process a first image captured by a first imaging device and a second image captured by a second imaging device; a displayer configured to display the processed first image and the processed second image; and a controller configured to, in response to a first characteristic value of the first image and a second characteristic value of the second image being different from each other, calibrate at least one of the first image and the second image so that the first characteristic value is equal to the second characteristic value.

The display apparatus may further include the first imaging device and the second imaging device, wherein the first imaging device and the second imaging device have at least one of bilateral symmetry and a same height with respect to the displayer.

The display apparatus may further include a first connector to which the first imaging device is detachably mounted, and a second connector to which the second imaging device is detachably mounted, wherein the first connector and the second connector have at least one of bilaterally symmetry and a same height with respect to the displayer.

The display apparatus may further include a storage configured to store the calibrated at least one of the first image and the second image.

The display apparatus may further include an optical characteristic measurer configured to measure the first characteristic value of the first image displayed on the displayer and to measure the second characteristic value of the second image displayed on the displayer, wherein the controller is configured to determine whether the first characteristic value and the second characteristic value measured by the optical characteristic measurer are equal to each other.

The controller may be configured to use the first characteristic value as a reference characteristic value and calibrates the second image so that the second characteristic value is equal to the reference characteristic value.

The display apparatus may further include a user input section configured to receive a command input by a user to input a command, wherein the controller is configured to obtain, from the user, a target characteristic value through the user input section, and to calibrate the first image and the second image so that the first characteristic value and the second characteristic value are equal to the obtained target characteristic value.

The controller may be configured to use a characteristic value corresponding to a preset imaging device, among the first imaging device and the second imaging device, as a reference characteristic value and calibrate a characteristic value of an image of an other imaging device, among the first imaging device and the second imaging device, so that the characteristic value is equal to the reference characteristic value.

The controller may be configured to control the communicator to transmit image data containing the calibrated at least one of the first image and the second image and voice data to an other party display apparatus that is participating in the 3D image communication.

According to an aspect of another exemplary embodiment, there is provided a method of controlling a display apparatus for three-dimensional (3D) image communication, the method including: obtaining a first characteristic value of a first image captured by a first imaging device; obtaining a second characteristic value of a second image captured by a second imaging device; comparing the obtained first characteristic value and the obtained second characteristic value; and calibrating, in response to the obtained first characteristic value being different from the obtained second characteristic value according to the comparing, at least one of the first image and the second image so that the first characteristic value is equal to the second characteristic value.

The calibrating may include storing the calibrated at least one of the first image and the second image.

The comparing may include displaying the captured first image and the captured second image, measuring the first characteristic value from the displayed first image and the second characteristic value from the displayed second image, and determining whether the measured first characteristic value is equal to the measured second characteristic value.

The calibrating may include using the first characteristic value as a reference characteristic value and calibrating the second image so that the second characteristic value is equal to the reference characteristic value.

The calibrating may include obtaining, from a user input, a target characteristic value, and calibrating the first image and the second image so that the first characteristic value and the second characteristic value are equal to the obtained target characteristic value.

The calibrating may include using a characteristic value corresponding to a preset imaging device, among the first imaging device and the second imaging device, as a reference characteristic value and calibrating a characteristic value of an image of an other imaging device, among the first imaging device and the second imaging device, so that the characteristic value is equal to the reference characteristic value.

The method may further include transmitting image data containing the calibrated at least one of the first image and the second image and voice data to an other party display apparatus participating in the 3D image communication.

According to an aspect of another exemplary embodiment, there is provided a method of controlling image processing for three-dimensional (3D) image communication, the method including: obtaining first image captured by a first imaging device and a second image captured by a second imaging device; and calibrating at least one of the first image and the second image so that a first characteristic value of the first image is equal to a second characteristic value of the second image.

The calibrating may include measuring the first characteristic value from the obtained first image and the second characteristic value from the obtained second image; determining whether the measured first characteristic value is equal to the measured second characteristic value; and calibrating the at least one of the first image and the second image in response to the measured first characteristic value not being equal to the measured second characteristic value according to the determining.

The calibrating may include using the first characteristic value as a reference characteristic value and calibrating the second image so that the second characteristic value is equal to the reference characteristic value.

According to aspects of exemplary embodiments, users can perform image communication while maintaining eye contact with each other.

Also, according to aspects of exemplary embodiments, images having the same characteristics are provided during 3D image communication to provide the 3D image communication of high quality.

### BRIEF DESCRIPTION OF THE DRAWINGS

The above and/or other aspects will become apparent and more readily appreciated from the following description of exemplary embodiments, taken in conjunction with the accompanying drawings, in which:

FIGS. 1 and 2 show examples of a display apparatus;

FIG. 3 is a block diagram of a display apparatus according to an exemplary embodiment;

FIG. 4 is a block diagram of a display apparatus according to another exemplary embodiment;

FIGS. 5A and 5B show an example of calibration operations using an optical characteristic measurer in a display apparatus according to an exemplary embodiment;

FIGS. 6A and 6B show an example of calibration operations using an imaging device in a display apparatus according to an exemplary embodiment;

FIG. 7 is a control flowchart showing operations of a display apparatus according to an exemplary embodiment; and

FIG. 8 is a control flowchart showing operations of a display apparatus according to another exemplary embodiment.

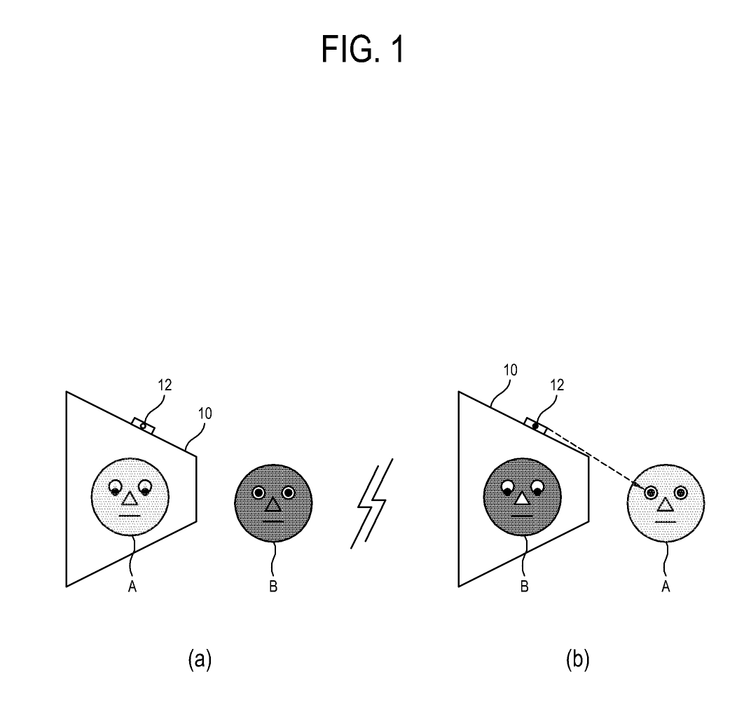

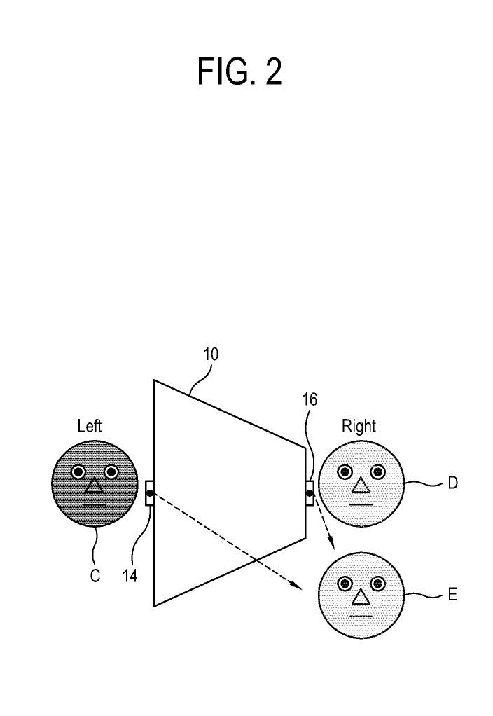

### DETAILED DESCRIPTION OF EXEMPLARY EMBODIMENTS

Below, exemplary embodiments will be described in detail with reference to accompanying drawings. Exemplary embodiments may be achieved in various forms, and an exemplary embodiment is not limited to the following descriptions. For convenience, the following exemplary embodiments describe only configurations directly related to the present inventive concept, and the descriptions the other configurations will be omitted. Further, like numerals refer to like elements throughout. Hereinafter, expressions such as “at least one of,” when preceding a list of elements, modify the entire list of elements and do not modify the individual elements of the list.

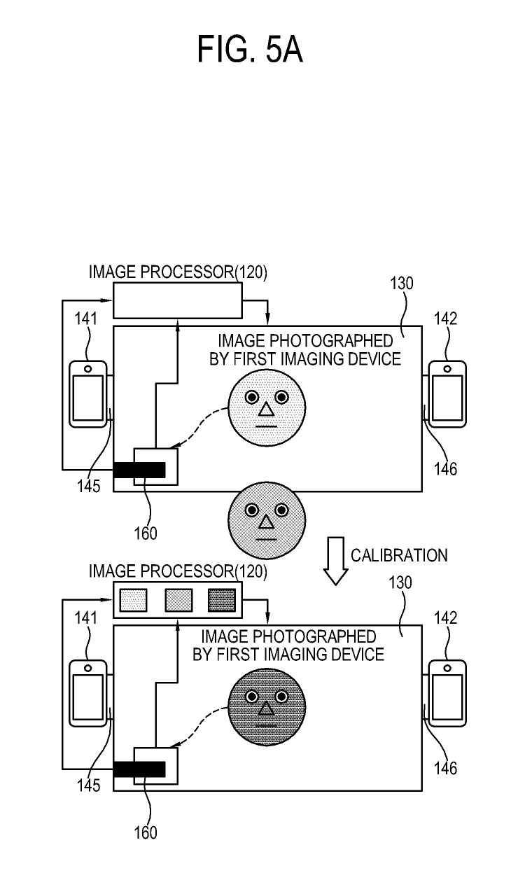

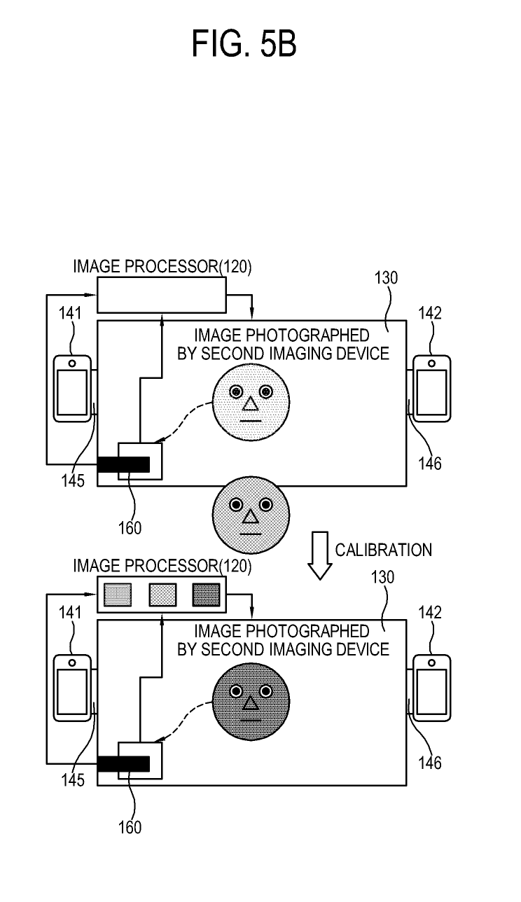

In a display apparatus 1 according to an exemplary embodiment, a plurality of imaging devices 141 and 142 (see FIGS. 5A and 5B) for image communication have bilateral symmetry at one height in a center region with respect to the displayer 130, so that users can conduct image communication while maintaining eye contact with each other. Also, in a 3D image communication, the plurality of imaging devices 141 and 142 photograph (i.e., capture) a user and transmit the photographed image to an other party display apparatus 1, so that the other party can communicate with the user while viewing a 3D image of the user. However, a difference in a characteristic between the plurality of imaging devices 141 and 142 may cause left and right images for the 3D image to have different characteristics. Therefore, the users may be aware of the difference and be uncomfortable or unsatisfied with the images. According to an exemplary embodiment, the images of the plurality of imaging devices 141 and 142 for the 3D image are calibrated to have the same characteristic values, thereby offering 3D image communication of high quality.

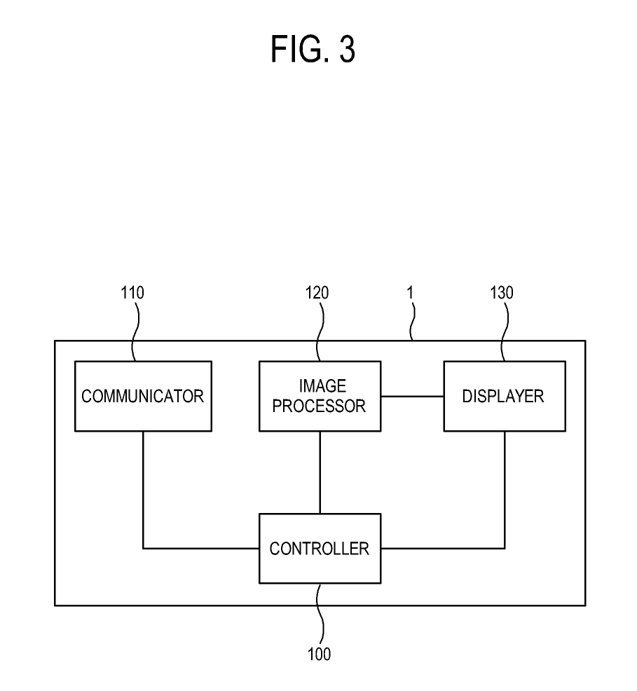

FIG. 3 is a block diagram of a display apparatus 1 according to an exemplary embodiment. Referring to FIG. 3, the display apparatus 1 may include a communicator 110, an image processor 120, a displayer 130, and a controller 100. Here, the display apparatus 1 may be achieved by a smart television (TV), a multi-vision display, a display system where one image is displayed through a plurality of display apparatuses, a user terminal capable of displaying an image, etc.

The communicator 110 receives a signal based on an external input, and transmits the received signal to the image processor 120 or the controller 100. The communicator 110 may receive a signal corresponding to an external input through a wired manner as various external input cables are connected thereto, or may receive a signal through a wireless manner complying with wireless communication standards.

The communicator 110 may include a plurality of connectors to which the cables are respectively connected. The communicator 110 may receive a signal based on the connected external input, for example, a broadcasting signal, an image signal, a data signal, etc., based on a high definition multimedia interface, a universal serial bus (USB), a component, or the like standards, or receive communication data through a communication network.

The communicator 110 may include an element for receiving a signal/data from the external input, as well as various additional elements such as a wireless communication module for wireless communication, a tuner for selecting the broadcasting signal, etc., in accordance with designs of the display apparatus 1. In addition to receiving the signal from an external device, the communicator 110 may transmit information/data/signal of an image processing device to the external device. That is, the communicator 110 is not limited to an operation of receiving the signal from the external device, but may be achieved by an interactive interface. The communicator 110 may receive a control signal for selecting a user interface (UI) from a plurality of control devices. The communicator 110 may be achieved by a communication module for short-range wireless communication such as Bluetooth, infrared (IR), ultra wideband (UWB), Zigbee, etc., or by a communication port for wireless communication such as IEEE 802.11. The communicator 110 may be utilized for various purposes, for example, transmitting/receiving a command and data for operating a display in addition to the control signal for selecting a user interface (UI).

One or more exemplary embodiments are not limited with respect to the types of image processing performed by the image processor 120. For example, the image processing may include at least one of de-multiplexing for dividing a predetermined signal into signals corresponding to characteristics, decoding corresponding to image format of an image signal, de-interlacing for converting an interlace-type image signal into a progressive type image signal, noise reduction for improving image quality, detail enhancement, frame refresh rate conversion, etc. The image processor 120 may include a decoder for decoding a source image corresponding to an image format of an encoded source image, and a frame buffer for storing the decoded source image per frame.

By way of example, the image processor 120 may be achieved by a system-on-chip (SOC) where many operations are integrated, or an image processing board where individual elements for independently performing such processes are mounted on a printed circuit board, and built in the display apparatus 1.

The image processor 120 performs various image processes that may be previously set with regard to a broadcasting signal including the image signal received from the receiver, and a source image including the image signal received from an image source. The image processor 120 outputs an image signal experienced such processes to the display apparatus 1, so that the processed source image can be displayed on the display apparatus 1.

The displayer 130 may display an image based on the image signal output from the image processor 120. Various types of displays may be implemented in the displayer 130 according to various exemplary embodiments. For example, the displayer 130 may be achieved by various display types such as liquid crystal, plasma, a light-emitting diode, an organic light emitting diode, a surface-conduction electron-emitter, a carbon nano-tube, nano-crystal, etc.

The displayer 130 may include an additional element in accordance with its type. For example, if the displayer 130 is a liquid crystal type, the displayer 130 may include a liquid crystal display panel, a backlight for emitting light to the panel, and a panel driving substrate for driving the panel.

The displayer 130 displays an image based on the image signal processed by the image processor 120. As described above, the displayer 130 may include a liquid crystal display (LCD), a a plasma display panel (PDP), an organic light emitting display (OLED), etc. In this case, the displayer 130 may include an LCD panel, panel, a PDP panel, an OLED panel, etc.

The displayer 130 may display an image and a color calibration process. The displayer 130 may include a display panel on which an image is displayed, and a panel driver to process an input image signal to be displayed as an image on the display panel, of which detailed operations are not limited. The image signal received from an external input source through the interface may experience the image processing such as decoding, de-interlacing, scaling, etc., and be displayed on the displayer 130. If the controller 100 (to be described below) performs the color calibration in accordance with a user's instructions, the display 120 may display the color calibration process including a color patch window, a color calibration state window, etc.

If a first characteristic value of a first image photographed (i.e., captured) by the first imaging device 141 and a second characteristic value of a second image photographed by the second imaging device 142 are different, the controller 100 calibrates at least one of the first image and the second image so that the first characteristic value and the second characteristic value can be equal to or correspond to each other.

Although the present exemplary embodiment is with reference to a display apparatus 1 including a displayer 130, it is understood that one or more other exemplary embodiments are not limited thereto, and may be implemented in a device that does outputs an image to be displayed on an external display device (e.g., a set-top box, an audio/video receiver, an optical recording media player, a network streaming device, etc.)

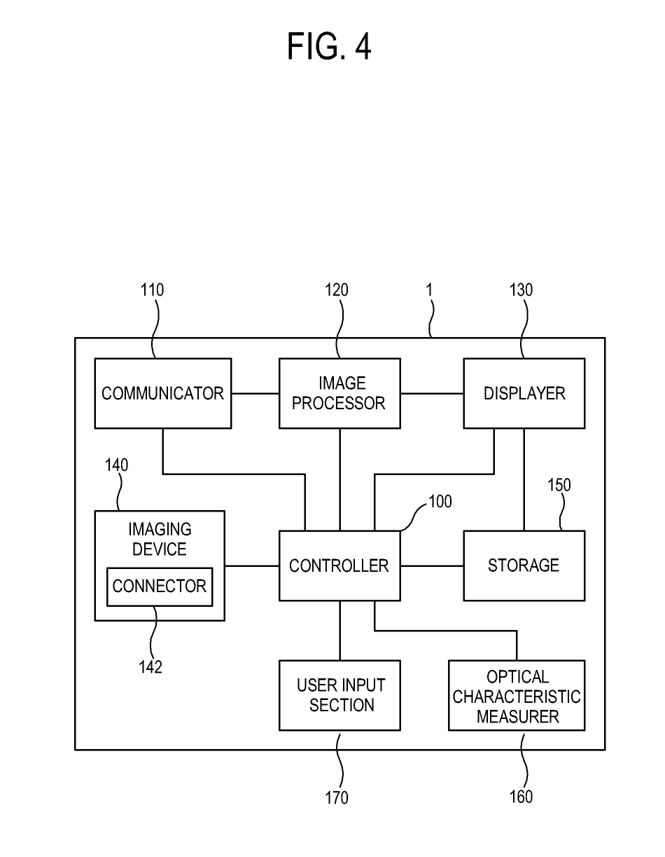

FIG. 4 is a block diagram of the display apparatus 1 according to another exemplary embodiment. Referring to FIG. 4, the display apparatus 1 may include an imaging section 140 including a connector 144, a storage 150, an optical characteristic measurer 160, and a user input section 170 in addition to the elements shown in FIG. 3.

The imaging section 140 may include the imaging devices 141 and 142 such as cameras for photographing a user. The imaging section 140 may be included in or mounted to the display apparatus 1. Also, the imaging section 140 may include the connector 144 and employ the cameras 141 and 142 of user terminals, e.g., of the smart phone as an example of external imaging devices 141 and 142. Here, the connector 144 may be provided so as to fasten the external imaging devices 141 and 142, and may have various types of interfaces.

The imaging section 140 includes a plurality of connectors 144 and a plurality of imaging devices 141 and 142. However, in the present exemplary embodiment, the image section 140 for photographing a user is itself an imaging device 141 or 142.

The storage 150 may be achieved by a nonvolatile memory (e.g., a writable read only memory (ROM)) that maintains data even though the display apparatus 1 is powered off, and reflects a user's change thereon. That is, the storage 150 may be provided as a flash memory, an erasable programmable read only memory (EPROM), an electrically erasable and programmable read only memory (EEPROM), etc.

The optical characteristic measurer 160 may include a sensor for calibration in order to measure an optical characteristic of an image. The optical characteristic measurer 160 may be included in the displayer 130 in the form of a sensor, like a camera 140 attached to or aimed by the displayer 130. For instance, the optical characteristic measurer 160 may be a smart phone, in which optical characteristic information can be acquired by an application using the camera in the smart phone, and the photographed image is transmitted to the controller 100 to thereby calculate an optical characteristic. Alternatively, the optical characteristic measurer 160 may employ a camera or wireless transmitter, thereby acquiring the optical characteristic information, i.e., the characteristic value of the image.

The user input section 170 transmits various preset control commands or information in accordance with a user's operations or inputs to the controller 100. The user input section 170 may be achieved by a menu-key or input panel installed on an outside surface of the display apparatus 1, a remote controller provided separately and remotely from the display apparatus 1, etc. Further, the user input section 170 may be integrated into the displayer 130. If the displayer 130 includes a touch screen, a user may touch an input menu displayed on the displayer 130 so that a preset command can be transmitted to the controller 100.

The user input section 170 receives a user's motion and voice. The user's motion includes a touch input. The user input section 170 may receive the user's motion and voice directly, or receive information about the user's motion and voice from an external device.

According to an exemplary embodiment, the display apparatus 1 further includes the first imaging device 141 and the second imaging device 142, and the first imaging device 141 and the second imaging device 142 may be provided to have at least one of bilateral symmetry and a same height with respect to the displayer 130. The plurality of imaging devices 141 and 142 have bilateral symmetry at one height in a center region with respect to the displayer 130 so that users can conduct image communication (e.g., video conferencing) while keeping eye contact with the other party.

According to an exemplary embodiment, the display apparatus 1 includes a first connector 145 and a second connector 146 (see FIGS. 5A and 5B) to which the first imaging device 141 and the second imaging device 142 are detachably mounted, respectively, and in which the first connector 145 and the second connector 146 may be provided to have at least one of the bilateral symmetry and the same height with respect to the displayer 130.

The controller 100 processes the characteristic values of the plurality of photographed images to be equal to each other, and stores at least one calibrated image in the storage 150.

The controller 100 controls the displayer 130 to display an image photographed by the imaging section 140, and determines whether or not a first characteristic value of a first image photographed by the first imaging device 141 and measured by the optical characteristic measurer 160 and a second characteristic value of a second image photographed by the second imaging device 142 and measured by the optical characteristic measurer 160 are equal to each other. In this regard, the controller 100 may display both of the first image and the second image simultaneously, or consecutively.

With respect to a characteristic value of one among the plurality of photographed images, the controller 100 may calibrate the characteristic values of the other photographed images. According to another exemplary embodiment, the controller 100 may calibrate the characteristic values of all photographed images with respect to each other. For example, the controller 100 may average characteristic values of all or some photographed images and calibrate the characteristic values of all photographed images based thereon. Moreover, according to another exemplary embodiment, the controller 100 may calibrate the characteristic values of photographed images based on a pre-stored reference image or pre-stored target characteristic value.

If a user inputs a target characteristic value of an image to the user input section 170, the controller 100 may adjust the characteristic values of the plurality of photographed images to be equal to the target characteristic value.

The controller 100 may calibrate the characteristic values of the other images with respect to the characteristic value of preset imaging devices 141 and 142.

The controller 100 may control the communicator 110 to transmit image data containing at least one of the first and second calibrated images and voice data to the display apparatus 1 of the other party.

FIGS. 5A and 5B show an example of calibration operations using the optical characteristic measurer 160 in the display apparatus 1 according to an exemplary embodiment.

The top portions of FIGS. 5A and 5B correspond to a state before calibration. In particular, the top portion of FIG. 5A illustrates that a first image photographed by a camera 141 of a first user terminal connected and mounted to a first connector 145 of the displayer 130 is displayed on the displayer 130 and the displayed first image is measured by the optical characteristic measurer 160. Likewise, the top portion of FIG. 5B illustrates that a second image photographed by a camera 142 of a second user terminal connected and mounted to a second connector 146 of the displayer 130 is displayed on the displayer 130 and the displayed second image is measured by the optical characteristic measurer 160.

The characteristic values of the first and second images photographed at the left and right sides are measured and compared, and if the first and second images are different, the characteristic value of the image of one of the imaging devices 141 and 142 is used as a reference to calibrate the characteristic value of the image of the other device 141 or 142. Also, a target characteristic value input by a user may be employed to calibrate the characteristic values of both images of the imaging devices 141 and 142. When the calibration is performed by the input characteristic value or the reference characteristic value, the image of the other imaging device 141 or 142 may not be calibrated. In this case, the characteristic value of one image among the plurality of photographed images may be used as the reference to calibrate the characteristic value of the other photographed image. Here, the calibration may refer to calibration for an image frame itself, or refer to a setting value or setting control command that is calculated and transmitted for changing the settings of the displayer 130 of the other party display apparatus 1.

FIGS. 5A and 5B illustrate that the optical characteristic measurer 160 is employed as a calibration reference to cause the first image and the second image to have the same characteristic value.

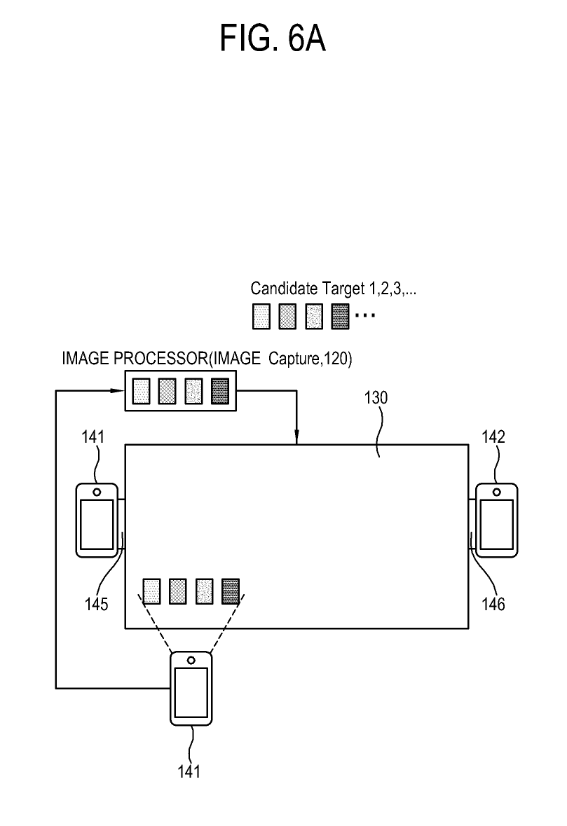

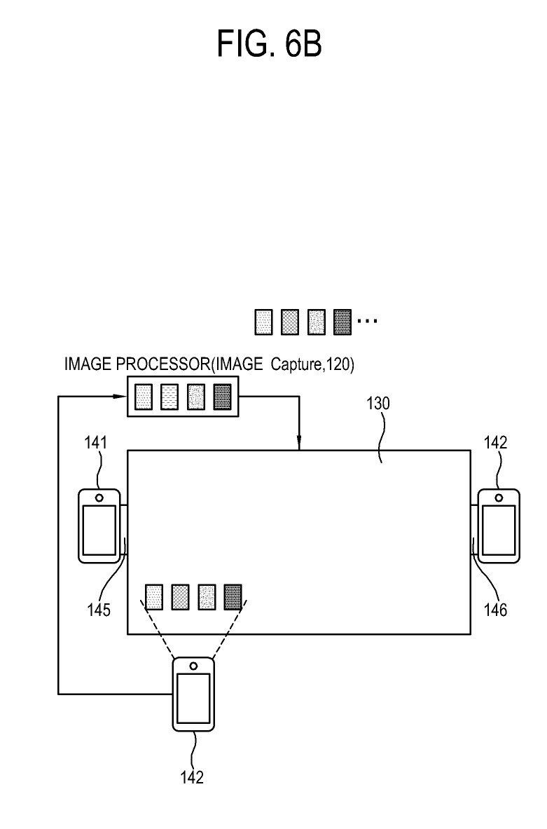

FIGS. 6A and 6B show an example of calibration operations using an imaging device 141 and 142 in a display apparatus 1 according to an exemplary embodiment.

Referring to FIGS. 6A and 6B, the images are previously taken by the cameras 141 and 142 of the left and right user terminals before starting the image communication, and a difference in the characteristic values between the first and second images photographed by the left and right user terminals, i.e., the first imaging device 141 and the second imaging device 142, is calculated. When the image communication starts, the calculated difference is applied to the calibration for the image, and transmitted to the other party display apparatus 1.

The calibrated image may be stored in the storage 150.

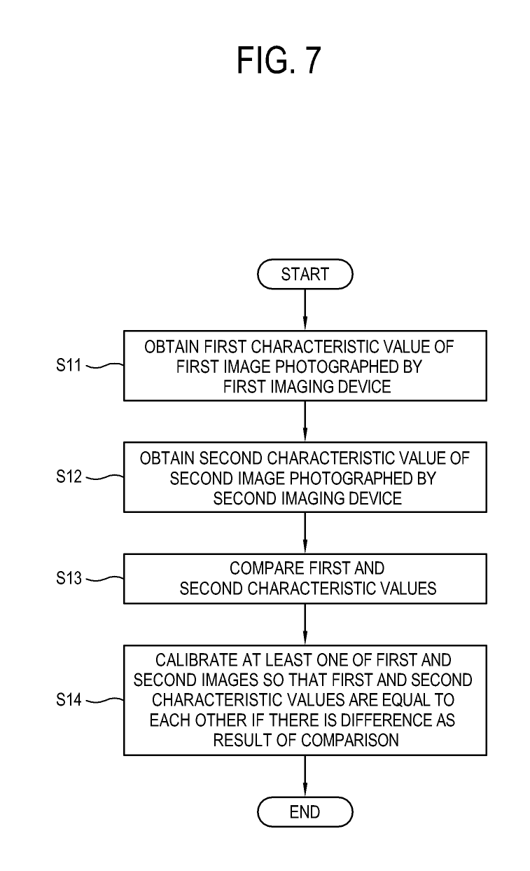

FIG. 7 is a control flowchart showing operations of a display apparatus 1 according to an exemplary embodiment.

Referring to FIG. 7, a first characteristic value is obtained from a first image photographed by a first imaging device 141 (operation S11).

A second characteristic value is obtained from a second image photographed by a second imaging device 142 (operation S12).

The first characteristic value and the second characteristic value are compared with each other (operation S13).

If there is difference between the first characteristic value and the second characteristic value as a result of the comparison, at least one of the first image and the second image are calibrated so that the first characteristic value and the second characteristic value become equal to each other (operation S14).

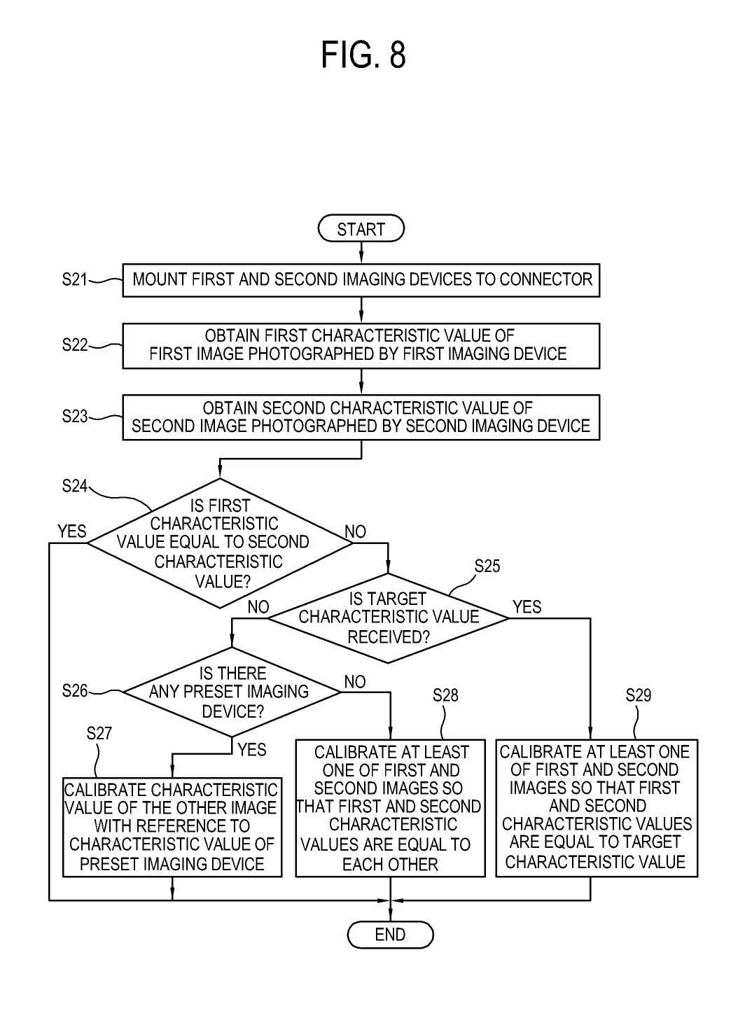

FIG. 8 is a control flowchart showing operations of a display apparatus 1 according to another exemplary embodiment.

Referring to FIG. 8, a first imaging device 141 and a second imaging device 142 are mounted to connectors 144 (operation S21). Here, the first imaging device 141 and the second imaging device 142 may be user terminals.

A first image photographed by the first imaging device 141 is displayed on a displayer 130. A characteristic value of the first image displayed on the displayer 130 is measured by an optical characteristic measurer 160 and transmitted to the controller 100, thereby obtaining the first characteristic value (operation S22).

A second image photographed by a second imaging device 142 is displayed on the displayer 130. A characteristic value of the second image displayed on the displayer 130 is measured by the optical characteristic measurer 160 and transmitted to the controller 100, thereby obtaining the second characteristic value (operation S23).

The first characteristic value and the second characteristic value are compared to determine whether they are equal to each other (operation S24). If there is no difference between the first characteristic value and the second characteristic value as a result of the comparison, the display apparatus 1 stops the operations according to an exemplary embodiment.

If there is a difference between the first characteristic value and the second characteristic value as a result of the comparison, it is determined whether a user inputs a target characteristic value (operation S25).

If it is determined that the target characteristic value is input, at least one of the first image and the second image is calibrated to be equal to the target characteristic value (operation S29)

If it is determined that the target characteristic value is not input in the operation S25, it is determined whether there is a preset imaging device 140 for calibration (operation S26).

If there is the preset imaging device 141 or 142, the characteristic value of the image of the other device 141 or 142 is calibrated to be equal to the characteristic value of image of the preset imaging device 141 or 142 (operation S27).

If there is no preset imaging device 141 or 142 in the operation S26, at least one of the first image and the second image is calibrated so that the first characteristic value and the second characteristic value become equal to each other (operation S28). Here, if there is no preset imaging device 141 or 142 in the operation S26, one of the first imaging device 141 and the second imaging device 142 is used as the reference to calibrate the characteristic value of the other photographed image.

In the foregoing display apparatus 1, the first characteristic value of the first image photographed for 3D image communication by the first imaging device 141 and the second characteristic value of the second image photographed by the second imaging device 142 are compared, and if there is a difference between the first and second characteristic values, the image is calibrated so that the first characteristic value and the second characteristic value become equal to each other. Thus, the images having the same characteristics are provided during 3D image communication to offer the 3D image communication of high quality, and users can conduct image communication while keeping eye contact with each other.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more elements of the above-described apparatuses 1 can include circuitry, a processor, a microprocessor, etc., and may execute a computer program stored in a computer-readable medium.

Although a few exemplary embodiments have been shown and described, it will be appreciated by those skilled in the art that changes may be made in these exemplary embodiments without departing from the principles and spirit of exemplary embodiments. Therefore, the foregoing is to be considered as illustrative only. The scope of the invention is defined in the appended claims and their equivalents. Accordingly, all suitable modification and equivalents may fall within the scope of the invention.

What is claimed is:

1. A display apparatus for three-dimensional (3D) image communication, the display apparatus comprising:
a communicator configured to transmit and receive information for the 3D image communication;
an image processor configured to process a received image received through the communicator and to process a first image captured by a first imaging device and a second image captured by a second imaging device;
a displayer configured to display the processed first image and the processed second image; and
a controller configured to, in response to a first characteristic value of the first image and a second characteristic value of the second image being different from each other, calibrate at least one of the first image and the second image so that the first characteristic value is equal to the second characteristic value.

2. The display apparatus according to claim 1, further comprising:
the first imaging device and the second imaging device,
wherein the first imaging device and the second imaging device have at least one of bilateral symmetry and a same height with respect to the displayer.

3. The display apparatus according to claim 1, further comprising:
a first connector to which the first imaging device is detachably mounted; and
a second connector to which the second imaging device is detachably mounted,
wherein the first connector and the second connector have at least one of bilaterally symmetry and a same height with respect to the displayer.

4. The display apparatus according to claim 1, further comprising:
a storage configured to store the calibrated at least one of the first image and the second image.

5. The display apparatus according to claim 1, further comprising:
an optical characteristic measurer configured to measure the first characteristic value of the first image displayed on the displayer and to measure the second characteristic value of the second image displayed on the displayer,
wherein the controller is configured to determine whether the first characteristic value and the second characteristic value measured by the optical characteristic measurer are equal to each other.

6. The display apparatus according to claim 1, wherein the controller is configured to use the first characteristic value as a reference characteristic value and calibrates the second image so that the second characteristic value is equal to the reference characteristic value.

7. The display apparatus according to claim 1, further comprising:
a user input section configured to receive a command input by a user,
wherein the controller is configured to obtain, from the user, a target characteristic value through the user input section, and to calibrate the first image and the second image so that the first characteristic value and the second characteristic value are equal to the obtained target characteristic value.

8. The display apparatus according to claim 1, wherein the controller is configured to use a characteristic value corresponding to a preset imaging device, among the first imaging device and the second imaging device, as a reference characteristic value and calibrates a characteristic value of an image of an other imaging device, among the first imaging device and the second imaging device, so that the characteristic value is equal to the reference characteristic value.

9. The display apparatus according to claim 1, wherein the controller is configured to control the communicator to transmit image data containing the calibrated at least one of the first image and the second image and voice data to an other party display apparatus that is participating in the 3D image communication.

10. A method of controlling image processing for three-dimensional (3D) image communication, the method comprising:
obtaining a first characteristic value of a first image captured by a first imaging device;
obtaining a second characteristic value of a second image captured by a second imaging device;
comparing the obtained first characteristic value and the obtained second characteristic value; and
calibrating, in response to the obtained first characteristic value being different from the obtained second characteristic value according to the comparing, at least one of the first image and the second image so that the first characteristic value is equal to the second characteristic value.

11. The method according to claim 10, wherein the calibrating comprises storing the calibrated at least one of the first image and the second image.

12. The method according to claim 10, wherein the comparing comprises:
displaying the captured first image and the captured second image;
measuring the first characteristic value from the displayed first image and the second characteristic value from the displayed second image; and
determining whether the measured first characteristic value is equal to the measured second characteristic value.

13. The method according to claim 10, wherein the calibrating comprises using the first characteristic value as a reference characteristic value and calibrating the second image so that the second characteristic value is equal to the reference characteristic value.

14. The method according to claim 10, wherein the calibrating comprises:
obtaining, from a user input, a target characteristic value; and
calibrating the first image and the second image so that the first characteristic value and the second characteristic value are equal to the obtained target characteristic value.

15. The method according to claim 10, wherein the calibrating comprises using a characteristic value corresponding to a preset imaging device, among the first imaging device and the second imaging device, as a reference characteristic value and calibrating a characteristic value of an image of an other imaging device, among the first imaging device and the second imaging device, so that the characteristic value is equal to the reference characteristic value.

16. The method according to claim 10, further comprising transmitting image data containing the calibrated at least one of the first image and the second image and voice data to an other party display apparatus that is participating in the 3D image communication.

17. A non-transitory computer readable recording medium having recorded thereon a program executable by a computer for performing the method of claim 10.

18. A method of controlling image processing for three-dimensional (3D) image communication, the method comprising:
obtaining first image captured by a first imaging device and a second image captured by a second imaging device; and
calibrating at least one of the first image and the second image so that a first characteristic value of the first image is equal to a second characteristic value of the second image.

19. The method according to claim 18, wherein the calibrating comprises:
measuring the first characteristic value from the obtained first image and the second characteristic value from the obtained second image;
determining whether the measured first characteristic value is equal to the measured second characteristic value; and
calibrating the at least one of the first image and the second image in response to the measured first characteristic value not being equal to the measured second characteristic value according to the determining.

20. The method according to claim 18, wherein the calibrating comprises using the first characteristic value as a reference characteristic value and calibrating the second image so that the second characteristic value is equal to the reference characteristic value.
